(19) United States
(12) Patent Application Publication
(10) Pub. No.: US 2024/0286063 A1
(43) Pub. Date: Aug. 29, 2024

(54) SYSTEMS AND METHODS FOR REMOVAL OF IODINE FROM HYDROGEN IODIDE STREAMS

(71) Applicant: Honeywell International Inc., Charlotte, NC (US)

(72) Inventors: Christian Jungong, Depew, NY (US); Yuon Chiu, Denville, NJ (US); Haiyou Wang, Amherst, NY (US); Haluk Kopkalli, Staten Island, NY (US)

(21) Appl. No.: 18/570,422

(22) PCT Filed: Jul. 11, 2022
(86) PCT No.: PCT/US2022/073602

§ 371 Date: Dec. 14, 2023

Related U.S. Application Data
(60) Provisional application No. 63/222,813, filed on Jul. 16, 2021.

(51) Int. Cl. B01D 3/14; B01D 53/02; C01B 7/13

(52) U.S. Cl. CPC B01D 3/148; B01D 53/02; C01B 7/135

(57) ABSTRACT

Processes for producing and/or purifying hydrogen iodide (HI), including methods for removing iodine-containing species from a mixture including at least one iodine containing species and hydrogen iodide, as well as methods for removing elemental iodine and hydrogen triiodide from a mixture including at least one iodine containing species and hydrogen iodide.

### CROSS-REFERENCE TO RELATED APPLICATION

This application claims priority to Provisional Application No. 63/222,813, filed Jul. 16, 2021, which is herein incorporated by reference in its entirety.

### FIELD

The present disclosure generally relates to processes for producing Hydrogen iodide (HI) and trifluoroiodomethane (CF₃I). Specifically, the present disclosure relates to methods for removing iodine-containing species from a mixture comprised of the at least one iodine containing species and hydrogen iodide, as well as methods for removing elemental iodine and hydrogen triiodide from a mixture comprised of the at least one iodine containing species and hydrogen iodide.

### BACKGROUND

Hydrogen iodide is an important industrial chemical used as a reducing agent, as well as in the preparation of hydroiodic acid, organic and inorganic iodides, iodoalkanes. Various methods have been reported for preparing hydrogen iodide.

See, for example, N. N. Greenwood et al., The Chemistry of the Elements, 2nd edition, Oxford: Butterworth-Heineman. p 809-815, 1997, in which hydrogen iodide is prepared from the reaction of elemental iodine with hydrazine according to Equation 1 below:

$$2 {I}_{2} + {N}_{2} {H}_{4} □ 4 HI + {N}_{2} . \qquad Eq . 1$$

In another example, in Textbook of Practical Organic Chemistry, 3^{rd} edition, A. I. Vogel teaches that hydrogen iodide can be prepared by reacting a stream of hydrogen sulfide with iodine according to Equation 2 below:

$${H}_{2} S + {I}_{2} □ 2 HI + S . \qquad Eq . 2$$

Each of the above examples use costly starting materials, such as hydrogen sulfide or hydrazine, that restrict their application for large scale, economical preparation of hydrogen iodide. Additionally, the use of hydrazine for preparation of hydrogen iodide results in the formation of nitrogen gas as a byproduct. Separation of the nitrogen gas from the hydrogen iodide to purify the hydrogen iodide is difficult and expensive, thus adding to manufacturing costs. Similarly, the use of hydrogen sulfide results in the formation of sulfur, which is difficult to separate from unreacted iodine, again adding to manufacturing costs. Sulfur may poison any catalysts used, further adding to manufacturing costs.

As disclosed in U.S. patent application Ser. No. 16/849,213, hydrogen iodide can be prepared from elemental iodine and hydrogen gas, according to Equation 3 below:

$${H}_{2} + {I}_{2} □ 2 HI . \qquad Eq . 3$$

Such examples can more easily produce high-purity hydrogen iodide as no nitrogen or sulfur is produced.

However, hydrogen iodide is very difficult to handle due to its instability and reactivity. For example, hydrogen iodide decomposes in the presence of heat or light to form hydrogen and iodine. The iodine can in turn react with the hydrogen iodide to form hydrogen triiodide. Escape of hydrogen from the liquid phase further promote the decomposition hydrogen iodide as it shifts the equilibrium towards more production of elemental iodine and hydrogen.

Additionally, in the presence of moisture, hydrogen iodide forms hydroiodic acid which can corrode most metals. The instability and reactivity of hydrogen iodide makes it hard to store and to transport. As such, anhydrous hydrogen iodide is often prepared locally for immediate use. Additionally, organic impurities in the iodine could react during preparation of hydrogen iodide to form iodoalkanes such as methyl iodide, ethyl iodide and propyl iodide. Due to the reactivity of hydrogen iodide, it routinely contains elemental iodine from decomposition, which is detrimental to the purity, especially if it must be stored for a long period of time.

Furthermore, the presence of iodine-containing species, such as I₂ and HI₃, together with additional I₂ formed during the reaction, may cause increased corrosion of equipment and/or operational difficulties including flow, pressure control and plugging issues. These results are disadvantageous from the standpoints of reduced productivity of the desired product and an increased operational cost. Moreover, iodine may be a relatively expensive component of the feedstock used to make hydrogen iodide, so the ability to separate and recycle iodine may reduce operational costs.

There is need to develop methods to remove elemental iodine and other iodine containing species from hydrogen iodide, especially for applications where high-purity hydrogen iodide is desired or where iodine is intended to be recycled.

### SUMMARY

The present disclosure provides a process for removing an iodine-containing species from a mixture comprised of at least one iodine containing species and hydrogen iodide. Specifically, the present disclosure relates to a process for removing elemental iodine or hydrogen triiodide from a mixture comprised of the at least one iodine containing species and hydrogen iodide.

In one embodiment, the present disclosure provides a process for removing at least one iodine-containing species from a mixture comprised of at least one iodine-containing species and hydrogen iodide, the process including: providing a feedstock comprising the mixture, passing the feedstock through at least one gas-liquid contact unit, wherein the feedstock is contacted with a liquid comprising hydrogen iodide; and passing the feedstock to a further unit selected from the group comprising a column, a reactor, a compressor, a de-sublimator, and a condenser. In another embodiment, the present disclosure provides a process for removing at least one iodine-containing species from a mixture comprised of at least one iodine-containing species and hydrogen iodide, the process including: providing a feedstock comprising the mixture; and passing the feedstock through at least one column charged with an adsorbent material to obtain a stream with a lesser concentration of the at least one iodine-containing species than in the feedstock.

In another embodiment, the present disclosure provides a process for removing at least one iodine-containing species from a mixture comprising the at least one iodine-containing species and hydrogen iodide, the process including: passing the feedstock through at least one iodine-containing species removal unit configured to reduce the concentration of the at least one iodine-containing species; and passing the feedstock to a further unit selected from the group comprising a reactor, a distillation column, a heat exchanger, a compressor, a de-sublimator, and a condenser.

### BRIEF DESCRIPTION OF THE DRAWINGS

FIG. 1 is a simplified process flow diagram for making purified hydrogen iodide;

FIG. 2 is a process flow diagram for removal of iodine-containing species from a hydrogen iodide stream through an adsorption train; and

FIGS. 3-6 are embodiments of a process flow diagram for removal of iodine-containing species form a hydrogen iodide stream through quenching.

### DETAILED DESCRIPTION

### I. Definitions

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

Also, use of “a” or “an” is employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as either a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

The term “iodine-containing species” (ICS), as used herein, means elemental iodine, hydrogen triiodide, iodohydrocarbons, such as iodomethane, iodoketones, iodoaldehydes and the like.

The term “iodine-containing species removal unit” refers to a separation unit configured to at least partially reduce the concentration of at least one ICS in a process stream. Examples of ICS removal units include liquid-gas contact units and adsorption columns.

The term “adsorbent” refers to a material that has the ability to extract a substance from a gas, liquid or solid by causing the substance to adhere to the material without changing the properties thereof. In the present invention, the adsorbent is a material that can remove an iodine-containing species from a gas or liquid stream comprised of the iodine-containing species and hydrogen iodide. Examples of adsorbents include activated carbons, zeolites, silica, and the like.

### II. Overall Reaction Process

The present disclosure a method for removing an iodine-containing species from a mixture comprising at least one iodine-containing species and hydrogen iodide. Specifically, the present disclosure relates to a process to removing elemental iodine and hydrogen triiodide from a mixture comprised of the at least one iodine containing species and hydrogen iodide.

As disclosed in U.S. patent application Ser. No. 16/849,213, hydrogen iodide can be prepared from elemental iodine and hydrogen gas, according to Equation 3 below:

$${H}_{2} + {I}_{2} □ 2 HI . \qquad Eq . 3$$

Generally speaking, the anhydrous hydrogen iodide, may be produced from a reactant stream comprising hydrogen (H₂) and iodine (I₂). The reactant stream may consist essentially of hydrogen and iodine. The reactant stream may consist of hydrogen and iodine. The reactant stream may include recycled hydrogen iodide (HI). The process may include providing a vapor-phase reactant stream comprising hydrogen and iodine and reacting the reactant stream in the presence of a catalyst to produce a product stream comprising hydrogen iodide and unreacted iodine. The catalyst may include at least one selected from the group of nickel, cobalt, iron, nickel iodide (NiI₂), cobalt iodide (CoI₂), iron iodide (FeI₂ or FeI₃), nickel oxide, cobalt oxide, and iron oxide. The catalyst may be supported on a support. Alternatively, HI for the process of the present disclosure may be obtained from a storage tank, or from a process or equipment purifying HI.

For example, an embodiment of the present disclosure is directed to a process for purifying hydrogen iodide product that is prepared by the process described herein by reducing the amount of elemental iodine and/or hydrogen triiodide that may be present therein. These impurities arise from the process of producing HI, in which hydrogen triiodide may be formed and un-converted elemental iodine may remain.

The efficiency of the manufacture of the hydrogen iodide may be further enhanced by the recycling of the reactants. Recycling of elemental iodine is particularly important because it is an expensive raw material. However, recycling iodine presents challenges because it is a solid below 113.7° C. The present disclosure also provides processes for the removal of elemental iodine from hydrogen iodide that include recycling of iodine in an efficient and continuous manner.

The hydrogen and iodine may be anhydrous. The amount of water in the reactant stream may be minimized or reduced because the presence of moisture may result in the formation of hydroiodic acid, which is corrosive and can be detrimental to downstream equipment and process lines. In addition, recovery of the hydrogen iodide from the hydroiodic acid adds to the manufacturing costs.

The hydrogen may be substantially free of water, including any water by weight in an amount less than about 500 ppm, about 300 ppm, about 200 ppm, about 100 ppm, about 50 ppm, about 30 ppm, about 20 ppm, 10 ppm, 5 ppm, 2 ppm or about 1 ppm, or less than any value defined between any two of the foregoing values. Preferably, the hydrogen comprises any water by weight in an amount less than about 50 ppm. More preferably, the hydrogen comprises any water by weight in an amount less than about 10 ppm. Most preferably, the hydrogen comprises any water by weight in an amount less than about 5 ppm.

The iodine may be provided to the reactor from solid iodine continuously or intermittently added to a heated iodine liquefier to maintain certain level of liquid iodine in the liquefier. A positive pressure may be maintained in the liquefier to deliver liquid iodine to an iodine vaporizer via a liquid iodine flowmeter. The temperature of the iodine in the iodine liquefier may be maintained such that the temperature is high enough to melt iodine, but low enough to avoid vaporizing the iodine. The liquid iodine may be vaporized in the vaporizer and the iodine vapor leaving the vaporizer may then be mixed with the hydrogen gas from a hydrogen supply to form the reactant stream. In another embodiment, liquid iodine may be pre-mixed with hydrogen gas and/or recycle HI in a vaporizer to vaporize together to form the reactant stream. The reactant stream may then be fed to a tubular reactor that is preloaded with any of the catalysts described above and preheated to the reaction temperature. Process lines between the liquefier and the vaporizer may be insulated and optionally heat-traced to ensure that iodine remains liquid in these lines. Process lines carrying the iodine vapor and the hydrogen/iodine vapor mixture may be insulated and optionally heat-traced to ensure that the gas phase is maintained.

The product stream including hydrogen iodide, unreacted hydrogen, and unreacted iodine may be directed from the reactor to one or more iodine removal vessels or systems, as described herein.

A bottom stream of the product column may include the purified hydrogen iodide. Additional product columns may be added to increase the purity of the purified hydrogen iodide. The purified hydrogen iodide may be passed through an appropriate desiccant to remove any residual moisture before use in subsequent processes, such as any of the processes discussed above, for example. The purified hydrogen iodide may be provided directly to the subsequent processes. Alternatively, or additionally, the purified hydrogen iodide may be collected in the storage tank for short term storage before use in subsequent processes. The recycle of iodine and hydrogen may improve efficiency in the process for producing hydrogen iodide.

The iodine may also be substantially free of water, or anhydrous, including any water by weight in an amount less than about 3000 ppm, about 2000 ppm, about 1000 ppm, about 500 ppm, about 300 ppm, about 200 ppm, about 100 ppm, about 50 ppm, about 30 ppm, about 20 ppm, or about 10 ppm, or less than any value defined between any two of the foregoing values. Preferably, the iodine comprises any water by weight in an amount less than about 100 ppm. More preferably, the iodine comprises any water by weight in an amount less than about 30 ppm. Most preferably, the iodine comprises any water by weight in an amount less than about 10 ppm.

Elemental iodine in solid form is commercially available from, for example, SQM, Santiago, Chile, or Kanto Natural Gas Development Co., Ltd, Chiba, Japan. Hydrogen in compressed gas form is commercially available from, for example, Airgas, Radnor, PA.

In the reactant stream, a mole ratio of hydrogen to iodine may be as low as about 1:1, about 1.5:1, about 2:1, about 2.5:1, about 2.7:1, or about 3:1, or as high as about 4:1, about 5:1, about 6:1, about 7:1, about 8:1, about 9:1, or about 10:1, or within any range defined between any two of the foregoing values, such as about 1:1 to about 10:1, about 2:1 to about 8:1, about 3:1 to about 6:1, about 2:1 to about 5:1, about 2:1 to about 3:1, about 2.5:1 to about 3:1, or about 2.7:1 to about 3.0:1, for example. Preferably, the mole ratio of hydrogen to iodine is from about 2:1 to about 9:1. More preferably, the mole ratio of hydrogen to iodine is from about 2.5:1 to about 8:1. Most preferably, the mole ratio of hydrogen to iodine is from about 2.5:1 to 6:1.

The reactant stream may react in the presence of a catalyst contained within a reactor to produce a product stream comprising anhydrous hydrogen iodide according to Equation 3 above. The reactor may be a heated tube reactor, such as a fixed bed tubular reactor, including a tube containing the catalyst. The tube may be made of a metal such as stainless steel, nickel, and/or a nickel alloy, such as a nickel-chromium alloy, a nickel-molybdenum alloy, a nickel-chromium-molybdenum alloy, a nickel-iron-chromium alloy, or a nickel-copper alloy. The tube reactor may be heated, thus also heating the catalyst. The feed materials may be preheated before entering the reactor. Alternatively, the reactor may be any type of packed reactor, such as a multi-tubular reactor (e.g. a shell-and-tube reactor) in which the catalyst is packed into the tubes and with a heat transfer medium in contact with the outside of the tubes, for example. The reactor may operate isothermally or adiabatically.

The product stream of HI may contain about 30 wt. % or less of an iodine-containing species, being limited only by economic considerations. The product stream of HI may then be used as reactor feedstock for producing another product, such as trifluoroacetyl iodide (TFAI), CF₃I or KI.

Optionally, the product stream of HI may be substantially free of water, or anhydrous, including any water by weight in an amount less than about 1,000 ppm, about 500 ppm, about 300 ppm, about 200 ppm, about 100 ppm, about 50 ppm, about 30 ppm, about 20 ppm, or about 10 ppm, or less than any value defined between any two of the foregoing values. Preferably, the product stream of HI comprises any water by weight in an amount less than about 100 ppm. More preferably, the product stream of HI comprises any water by weight in an amount less than about 30 ppm. Most preferably, the product stream of HI comprises any water by weight in an amount less than about 10 ppm. Stated differently, water may be present in the product stream in an amount less than less than 0.1 wt. %, less than 0.01 wt. %, less than 0.001 wt. %, or any range including any two of these values as endpoints.

### III. Iodine Removal/Separation

The process as described herein comprises at least one system, method, and/or unit configured to remove or separate iodine-containing species (ICS) from a stream of HI. Multiple different units and configurations thereof may be used to remove iodine from HI, as will be described herein.

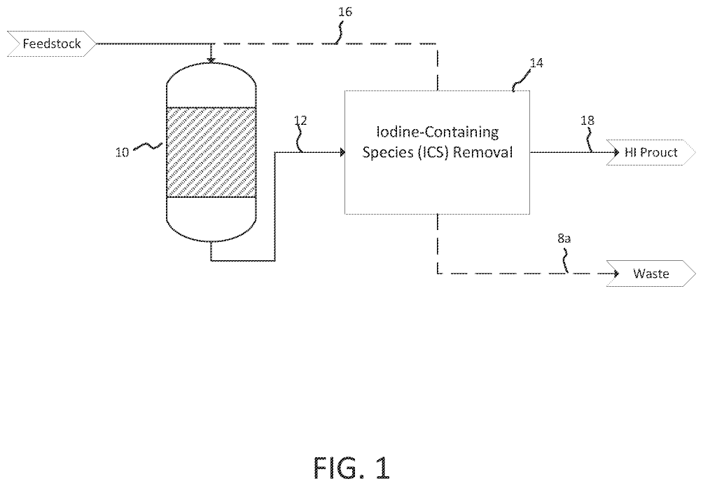

FIG. 1 illustrates a simplified process flow diagram for removal of iodine from an HI stream. Feedstock or reactant stream (comprising reagents, e.g. Hydrogen and Iodine, as well as any other carrier fluids and or byproducts or impurities) is fed to a reactor 10. Reactor 10 functions as described above and is generally configured to convert Hydrogen and Iodine into HI over a catalyst. Before being fed into the reactor, the feedstock may also be mixed with optional recycle stream 16. Recycle stream 16 may comprise unreacted reagents from reactor effluent stream 12, such as iodine and/or hydrogen, as well as hydrogen iodide.

The reactor effluent leaves reactor 10 in effluent stream 12 and then enters ICS removal system. Various units, configurations, and operating parameters for ICS removal system 14 will be described herein. At least a portion of ICS within the reactor effluent stream 12 are removed within ICS removal system 14, and an HI product stream 18 leaves ICS removal system 14, as well as an optional waste stream 8a and optional recycle stream (not shown). The HI product stream 18 may then be sent to another reactor, column, or other process unit to be further reacted or purified. As will be described herein, ICS removal system 14 comprises at least one separation unit, such as an adsorption column, a quenching unit, a distillation column, a condenser, or other separation units and combinations thereof.

A “stream” as indicated herein may refer to a single stream of components, or multiple streams, even when multiple streams may not be explicitly indicated. For example, while only one HI product stream is shown in FIG. 1, the overall process may contain multiple HI product streams that can feed into multiple other units. Any number of feedstock streams, product streams, reactor effluent recycle streams, waste streams, or any intermediate streams may be used. Any streams may be contained in any suitable pipe, conveyor, or other carrying system. The pipes used may also contain trace heating elements to provide heat to the process material and may reduce the amount of solidification of various compounds. The material within any given stream may be a gas, vapor, liquid, slurry, solid, supercritical fluid, or any combination thereof.

Additionally, a stream may be referred to as “stream #”, but for simplicity may be abbreviated to “S #”. For example, HI product stream 18 may also be referred to as S18.

In addition to the units shown and described herein, the process may comprise other standard units/systems that may not be illustrated or explicitly described but may be readily understood to be present by one of skill in the art in order to achieve suitable operating conditions. For example, the process may contain any number of pumps, compressors, valves, flash tanks, tanks, heat exchangers, mixers, filters, or any other standard process unit and combinations thereof. These units may be used to alter the temperature, pressure, state (e.g. vapor, liquid, etc.), flow rate, or any other characteristic of the process material. The processes and systems as described herein may also comprise purges and outlets at any number of stream locations in order to control and balance impurities and potentially reduce cyclic buildup of impurities in the system.

Furthermore, the process may comprise any number of measurement devices to measure characteristics of the process material. For example, the process may include any number of flow meters, temperature sensors, pressure sensors, gauges, analyzers, or any other suitable measurement device and combinations thereof. Any of the operating parameters of the process may also be controlled by any standard control systems or methods, such as with feedback loops, and may comprise any number of controllers, such as a PID controller.

Any of the separation units, systems, and methods as described herein to separate, remove, and/or recycle ICS from process streams may be positioned anywhere in a process, and/or at multiple points within a process. For example, at least one separation unit may be positioned in an effluent stream from a first reactor configured to produce HI, and before another reactor configured to produce CF₃I or any other iodinated compound, such as trifluoroacetyl iodide, for example. At least one separation unit may be placed before and/or after a reactor to remove iodine-containing compounds from a reactor feedstock and/or a reactor effluent respectively. In some embodiments, multiple separation units and/or systems may be used in series and/or in parallel. Additionally, any unit may comprise additional redundant or duplicate units. Having additional units may allow for the process to switch between multiple units to allow for cleaning or other maintenance, for example changing out a catalyst or adsorbent. Units may also be switched between to alternate between continuous and semi-continuous and/or batch processes. Having multiple units may also allow for additional safety and/or reliability in production in case of equipment failure.

Optionally, any stream in the process may be substantially free of water, or anhydrous, including any water by weight in an amount less than about 1,000 ppm, about 500 ppm, about 300 ppm, about 200 ppm, about 100 ppm, about 50 ppm, about 30 ppm, about 20 ppm, or about 10 ppm, or less than any value defined between any two of the foregoing values. Preferably, the any given stream comprises any water by weight in an amount less than about 300 ppm. More preferably, any given stream comprises any water by weight in an amount less than about 200 ppm. Most preferably, any given stream comprises any water by weight in an amount less than about 100 ppm. Stated differently, water may be present in any given stream in an amount, less than 0.1 wt. %, less than 0.01 wt. %, less than 0.001 wt. %, or any range including any two of these values as endpoints.

Any of the features described herein with respect to a given embodiment may also be used in or applied to any other embodiment as described herein.

### A. Adsorbent Separation

The use of an adsorbent is illustrated with respect to the preparation of removal of an iodine-containing species from hydrogen iodide, but other separation techniques, systems, and/or units may be used as disclosed herein. The use of such an adsorbent may provide for the efficient removal of an iodine-containing species from hydrogen iodide.

A stream containing hydrogen iodide (HI) may be passed through the at least one column charged with adsorbent materials after exiting a reactor, such as the reactor configured to produce HI. The HI may be in liquid form, vapor form, or any combination of the two. Preferably, the HI is in liquid form. The adsorption column is operated at a temperature as low as about −50° C., about −40° C., about −30° C., about −20° C., about −10° C., about 0° C., about 10° C., about 20° C., about 30° C. or about 40° C., or as high as about 50° C., about 60° C., about 70° C., about 80° C., about 90° C., about 100° C., about 110° C. or about 120° C. or within any range defined between any two of the foregoing values, such as about −50° C. to about 120° C., as about −30° C. to about 110° C. as about 0° C. to about 100° C., about 10° C. to about 90° C., about 20° C. to about 80° C., about 30° C. to about 70° C., about 40° C. to about 60° C., about 50° C. to about 70° C., about 40° C. to about 50° C., about 60° C. to about 90° C., about 0° C. to about 60° C. or about 20° C. to about 40° C., for example. Preferably, the adsorption column is operated at a temperature of about 0° C. to about 60° C. More preferably, the adsorption column is operated at a temperature of about 20° C. to about 50° C.

The adsorption column may be operated at a pressure slightly above the pressure of the next unit in the process, or at a pressure of as low as about −10 psig, 0 psig, about 5 psig, about 20 psig, about 50 psig, about 70 psig or about 100 psig, or as high as about 150 psig, about 200 psig, about 250 psig, about 300 psig, about 400 psig, about 500 psig, or about 600 psig or within any range defined between any two of the foregoing values, such as about −10 psig to about 600 psig, as about 0 psig to about 500 psig, as about 0 psig to about 400 psig about 5 psig to about 250 psig, about 20 psig to about 200 psig, about 50 psig to about 150 psig, about 5 psig to about 100 psig, about 20 psig to about 70 psig, or about 150 psig to about 250 psig, for example. Preferably, the adsorption column is operated at a pressure of about 5 psig to about 250 psig. More preferably, the adsorption column is operated at a pressure of about 10 psig to about 200 psig.

Non-limiting examples of suitable adsorption materials include silicalite (Al-free ZSM-5), modified silicalites, and aluminosilicate molecular sieves. ZSM-5, Zeolite Socony Mobil-5 (framework type MFI from ZSM-5 (five)), is an aluminosilicate zeolite belonging to the pentasil family of zeolites. Non-limiting examples of modified silicalites include transition metal modified silicalites, alkali metal modified silicalites, alkaline earth metal modified silicalites, rare-earth metal modified silicalite, metal oxide modified silicalites, and metal halide modified silicalites.

Silicalite is one of several forms (polymorphs) of silicon dioxide. It is a white solid. It consists of tetrahedral silicon centers and two-coordinate oxides. It may be prepared by hydrothermal reaction using tetrapropylammonium hydroxide followed by calcining to remove residual ammonium salts. The compound is notable in being 33% porous.

The product stream may be in contact with the adsorbent for a contact time as short as about 0.1 second, about 2 seconds, about 4 seconds, about 6 seconds, about 8 seconds, about 10 seconds, about 15 seconds, about 20 seconds, about 25 seconds, or about 30 seconds, or as long as about 40 seconds, about 50 seconds, about 60 seconds, about 70 seconds, about 80 seconds, about 100 seconds, about 120 seconds, about 1,800 seconds, about 3,600 seconds, about 1 hour, about 5 hours, about 10 hours, about 24 hours, about 48 hours, about 72 hours, about 144 hours, or about 168 hours, or about 240 hours. The product stream may be in contact with the adsorbent for a contact time of hours or even days, the residence time being limited only by economic considerations. For example, the product stream may be in contact with the adsorbent for a contact time within any range defined between any two of the foregoing values, such as about 0.1 seconds to about 240 hours, about 0.1 seconds to about 3,600 seconds, about 2 seconds to about 120 seconds, about 4 second to about 100 seconds, about 6 seconds to about 80 seconds, about 8 seconds to about 70 seconds, about 10 seconds to about 60 seconds, about 15 seconds to about 50 seconds, about 20 seconds to about 40 seconds, about 20 seconds to about 30 seconds, about 10 seconds to about 20 seconds, or about 100 seconds to about 120 seconds.

Additionally, adsorption could also be combined with distillation or other separation units or systems as a final treatment step to make high purity HI.

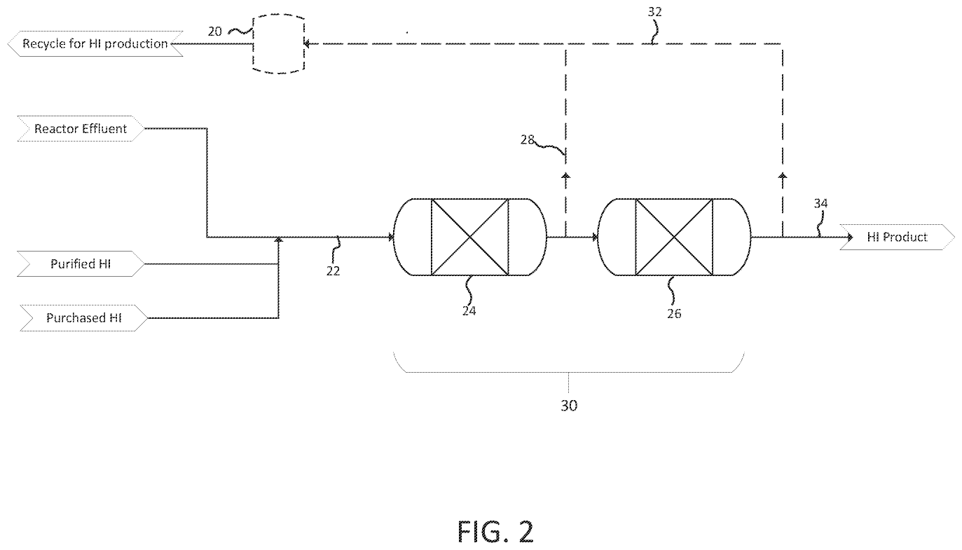

FIG. 2 is a process flow diagram showing a process for removing an iodine containing species from a mixture of iodine containing species and hydrogen iodide through adsorption. The mixture S22 can be from purchased HI, from HI production reactor effluent, and/or from purified HI obtained from HI production. S22 flows into iodine removal train 30. In the illustrated embodiment, iodine removal train 30 comprises two adsorption columns 24 and 26 positioned in series. Iodine removal train 30 is configured to at least partially remove ICS from the HI product S34 as described above. Once a portion of ICS have been removed from the mixture, the HI product stream 34 leaves the ICS removal train 30 and may be fed to a further reactor, column, or other unit.

Although the iodine removal train 30 consists of two iodine removal vessels operating in a series configuration, it is understood that the iodine removal train 30 may include two or more iodine removal vessels operation in a parallel configuration, more than two iodine removal vessels operating in a series configuration, and any combination thereof. It is also understood that the iodine removal train 30 may consist of a single iodine removal vessel.

The iodine collected in the first adsorption column 24 may be removed to form a first iodine recycle stream 28. Similarly, the iodine collected in the second adsorption column 26 may be removed to form a second iodine recycle stream 32. Each of the first iodine recycle stream 28 and the second iodine recycle stream 32 may be provided to an iodine liquefier 20 to recycle for HI production.

### B. Quenching Separation

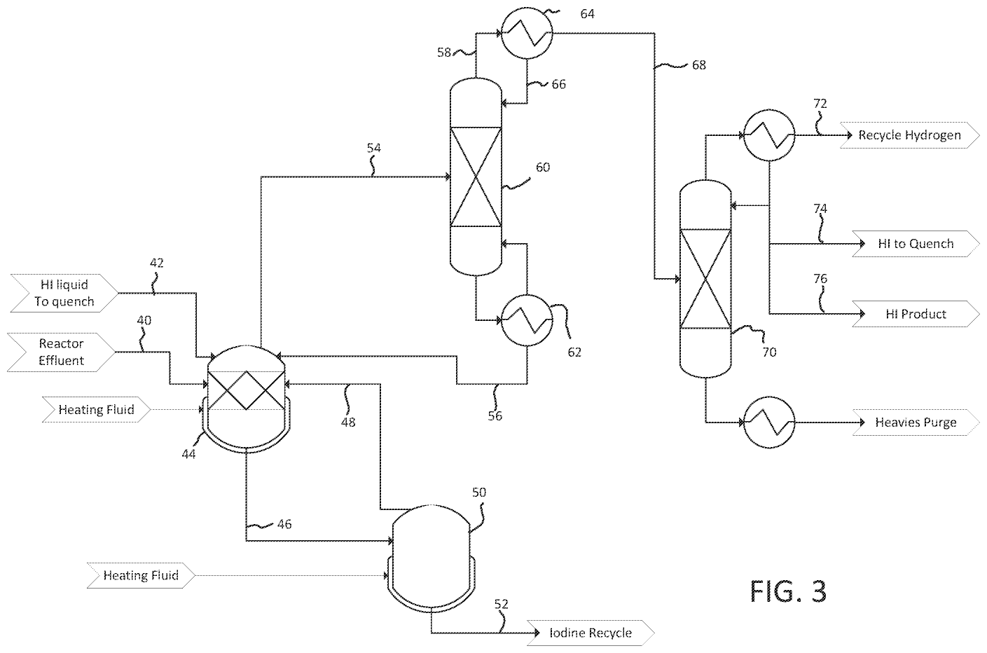

Other embodiments of ICS removal system 14 comprise a quenching unit, where reactor effluent which comprises HI, unreacted iodine, unreacted hydrogen, and potential by-products, small amounts of water, etc. is quenched with HI liquid. The HI liquid may capture the incoming ICS. Depending on the operating conditions, the captured ICS may be completely miscible with HI liquid forming one liquid phase, or the ICS may be a solid, forming a slurry with the HI liquid. The HI containing ICS may be partially evaporated to remove some of the HI, and the remaining HI and ICS may be recycled to the reactor. The quenching unit may contact the incoming reactor effluent (typically a vapor) with quenching liquid HI through any liquid-gas contacting device, such as through a sparger or multiple spargers submerged in HI liquid, distillation trays, shower curtain trays, slant trays, shed trays, random packing, structured packing, liquid spraying devices or nozzles, or any other suitable system/device or combinations thereof. Multiple embodiments of a quenching separation system are shown in FIGS. 3-6.

Referring first to FIG. 3, an exemplary quenching system for separating ICS from HI is shown. The quenching system comprises a quencher 44, which may be generally described as a liquid-gas contactor. The system also comprises an evaporator 50, a first distillation column 60 (with a condenser 64 and a reboiler 62), and a second distillation column 70.

The reactor effluent S40 is quenched with HI liquid S42 within quencher 44. The HI liquid or the contacting liquid can be the HI produced from the process and subsequently be replenished by HI produced from the process S42, or be replenished in part or in entirety by increasing the HI reflux S66, which results an increased flow of S56 as described in the distillation 60 below. The HI replenishing liquid may also be supplied from distillation column 70 via S74. Furthermore, HI may be added to the reactor effluent to assist diluting the iodine concentration in the vapor stream feeding to the quenching HI liquid, which may lessen the localized solid formation when it first contacts with the HI liquid. The quenching HI liquid may be introduced downstream of the quench 44, which will eventually flow back into quench 44.

The energy exchange between the hot reactor effluent vapor and the HI liquid may result in evaporating off a portion of the HI liquid. This evaporated HI S54 along with potentially a very small amount of I₂ from the quenching pool mixture is sent to a multi-stage distillation column 60 having sufficient rectifying stages and an overhead condenser 64 to remove the HI from the residual iodine. Since the partial pressure of I₂ is small relative to the HI coming off from the quenching pool mixture, the vapor content or the quantity of the I₂ may be managed within the distillation column without major solid deposit as I₂ exhibits some solubility in the HI liquid. This pre-conditioning step may eliminate any messy and solid deposit occurrence afterward, allowing a reliable downstream processing such as compressor and distillation operation. A portion of the evaporated HI vapor is condensed by the overhead condenser 64 and refluxed via S66 to the distillation column to dissolve this residual 12.

The distillation column bottoms S56, containing residual iodine and HI liquid, is sent back to the quencher 44 to replenish the HI liquid being evaporated. Quencher 44 may be integrated directly with distillation column 60, which may reduce the required amount of piping in the system.

The collected ICS in the quench pool is then sent to an evaporator 50 to evaporate a majority of the HI, leaving iodine and some HI in S52 to be collected or recycled to the reactor for HI production. The evaporated HI containing some ICS in S48 from this evaporator is sent back to the distillation 60 and/or to the quenching pool 44 to again separate out the HI and ICS in the same manner as described earlier.

As an alternative to the method of iodine collection described above, after the HI liquid pool has collected a sufficient amount of ICS, the hot reactor effluent vapor may be switched into another quencher to continue the ICS collection mode in the other quencher. The HI liquid pool containing ICS is then evaporated to remove a majority of the HI as described above, and sent back to the distillation and/or to the new quench pool to again separate out the HI and ICS in the same manner as described earlier. The remaining I2 and some HI may be recycled to the reactor. The two set of HI liquid pools/quenchers may be configured and sequenced in alternating ICS collection mode and ICS recycle mode. The advantage of having alternating, multiple, or redundant ICS collection equipment may provide the ability to readily isolate the equipment for service in the event of pluggage caused by the Iodine or other equipment failure or maintenance. This configuration may also eliminate or reduce need for a solid handling pump to boost the operating pressure necessary during the ICS recycle mode. Having multiple equipment 50, a higher pressure can be achieved by simply heating the vessel to increase its operating pressure, avoiding the operation of pumping a liquid containing solids.

The HI along with the H₂ in S68, having purified and separated from the ICS in the distillation column, leaves the distillation 60 overhead. It is then processed further to separate the HI from the H₂ stream to derive a recycle stream S72 comprising H₂ for recycling to the reactor. A portion of the liquefied HI S74 may be used to replenish the quenching operation as described earlier. The remaining liquefied HI portion S76 is the purified HI product, which may then be sent to another unit for further use or processing.

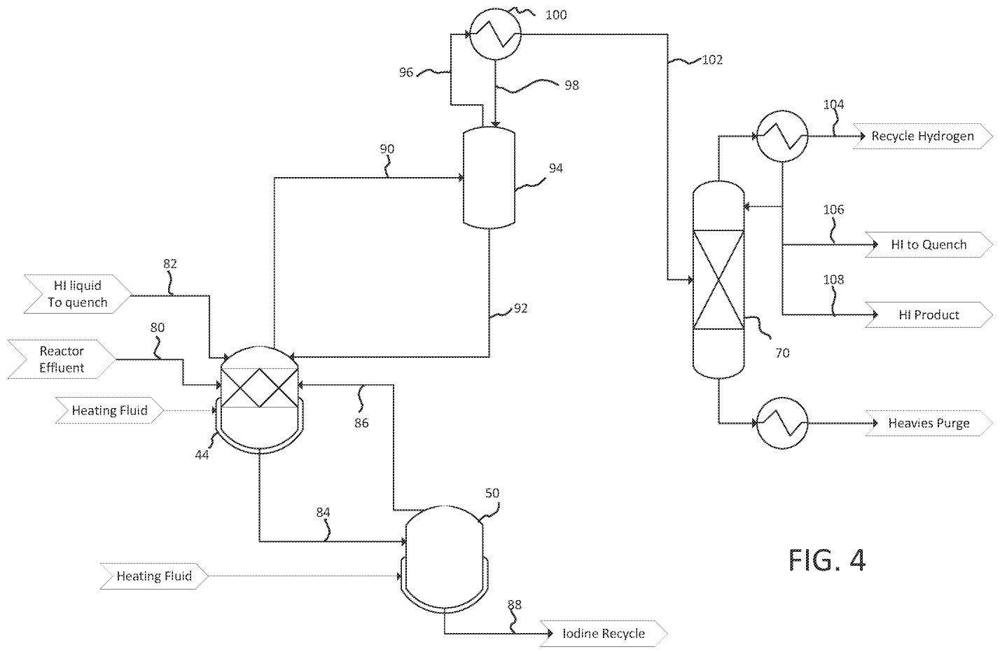

Referring now to FIG. 4, another exemplary quenching separation system is shown. The quenching system is similar to the quenching system shown in FIG. 3, but with another quenching unit 94 replacing distillation column 60. Quenching unit 94 may function similarly to 44, and may also use any suitable gas-liquid contact methods/devices/systems to contact quenching liquid with vapor/gas. 94 may operate at different operating conditions than 44.

Evaporated HI along with some ICS S90 from quencher 44 is sent to another quenching unit 94 or a series of quenching units in HI liquid to progressively capture the residual ICS, potentially reducing the amount of ICS in the stream to essentially negligible levels in the HI after the final stage. This pre-conditioning step may eliminate any messy and solid deposit occurrence afterward, allowing a reliable downstream processing such as compressor and distillation operation.

The HI vapor S96 emerging from the final stage of the quenching is partially condensed by an overhead condenser 100. The condensed liquid S98, containing HI and residual ICS, is then cascaded back to the previous stage and so on. This cascading liquid flow S92 will replenish the HI liquid being evaporated from the 1st stage quench pool and to allow all the ICS to collect in the 1st stage quench pool 44.

In lieu of a condenser 100, the subsequent quenching stages (eg. 94) may be equipped with jacketed cooling to mimic the function of a condenser, or the condenser 100 can be eliminated under certain operating conditions. Other aspects of the system shown in FIG. 4 (e.g. operation of quencher 44, evaporator 50, distillation column 70) may all be the same as or similar to the corresponding elements as described with respect to FIG. 3.

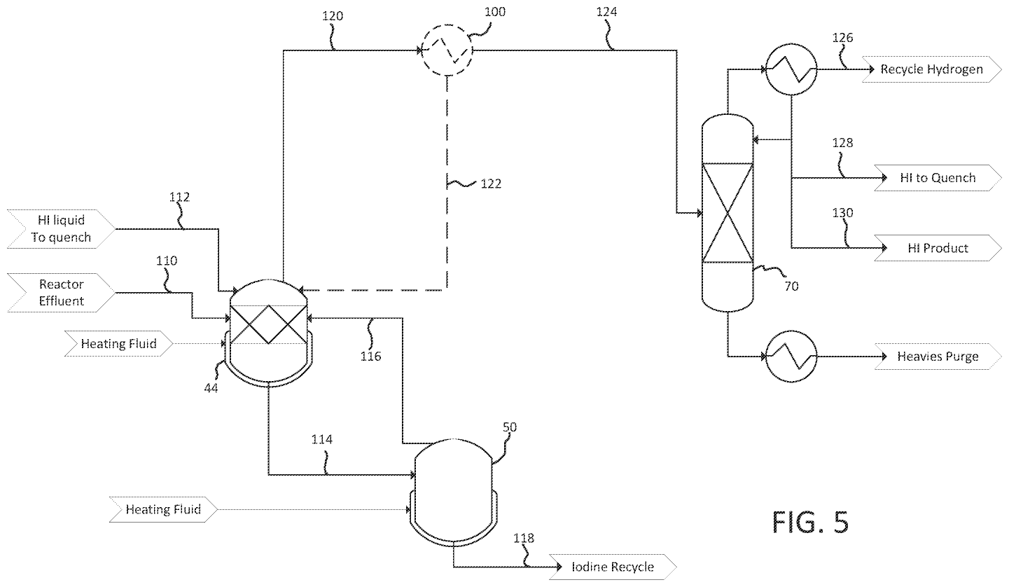

Referring now to FIG. 5, another exemplary ICS removal system is shown. The system shown in FIG. 5 is similar to that of FIG. 4, but without second quencher 94, and instead including optional condenser 100.

Evaporated vapor S120 from quencher 44 is partially condensed by an overhead condenser 100. The condensed liquid S122, containing HI and residual ICS is then cascaded back to the quenching 44. This configuration may be operated without optional condenser 100. The HI vapor S120 may already be well conditioned to eliminate any solid deposit occurrence afterward, allowing for reliable downstream processing such as compressor and distillation operation. The operation and functions of the other units shown in FIG. 5 are similar to or the same as the corresponding units in other embodiments.

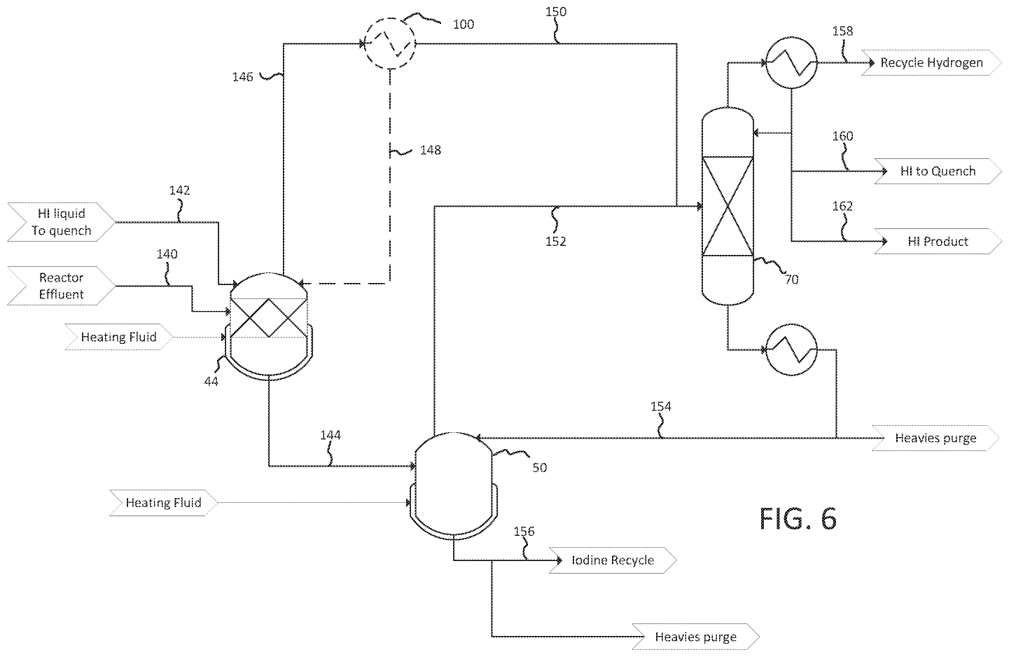

Referring now to FIG. 6, another embodiment of an ICS removal system is shown. The system shown in FIG. 6 is similar to FIG. 5, but with streams connecting the evaporator 50 to the second distillation column 70 instead of back to quencher 44.

The vapor S146 from quencher 44 is partially condensed by an optional overhead condenser 100. The condensed liquid S148, containing HI and residual ICS, is then cascaded back to the quenching 44. This configuration may operate without this optional condenser 100. The HI vapor S146 may already be conditioned to eliminate any solid deposit occurrence afterward, allowing for reliable downstream processing such as compressor or distillation operation.

The collected ICS in the quench pool is then sent to an evaporator 50 to evaporate a majority of the HI, leaving ICS and some HI S156 to be recycled to the reactor. The evaporated HI S152 containing some ICS from this evaporator is sent forward to a distillation column 70 to further purify HI.

As an alternative to the method described above, after the HI liquid pool has collected a sufficient amount of ICS, the reactor effluent vapor may be switched into another set of quenchers and evaporators to continue the ICS collection mode. The current HI liquid pool containing ICS may then be then evaporated to remove a majority of the HI, and passed to distillation column 70 to further purify HI in the same manner as described earlier. The remaining ICS and some HI S156 is recycled to the reactor. A heavies purge maybe taken from S156 or S154 to control the build-up of impurities.

The two sets of HI liquid pools/quenchers may be configured and sequenced in alternating ICS collection mode and ICS recycle mode. Having alternating, multiple, or redundant ICS collection equipment may provide the ability to readily isolate the equipment for service in the event of pluggage caused by the Iodine and not to interrupt the production of HI. This configuration may also eliminate the use of a solid handling pump to boost the operating pressure necessary during the ICS recycle mode. Having multiple evaporators 50, may allow for a higher pressure to be achieved by simply heating the vessel to increase its operating pressure, and may reduce the need to pump a stream containing solids.

Having removed essentially all the ICS, S152 comprising HI along with S150 comprising H₂ and HI, is then processed further in Column 70 to separate HI from H₂ to derive a recycle stream S158 comprising H₂ for recycling to the reactor. A portion of the liquefied HI S160 is used to replenish the quenching operation as described earlier. The remainder liquefied HI portion S162 is the purified HI product. The HI Distillation Column bottom S154, containing the recovered ICS predominately coming from the 50 and some HI, is recycled to 50 for further re-evaporation for ICS recovery.

The product HI stream from any of the above processes or variations thereof may be sent to further units for additional processing and/or reactions. For example, the HI product may be provided to a further reactor to produce trifluoroiodomethane (CF₃I) or any other iodinated compound which may then also be processed further. The product HI stream may be provided to any unit to alter the process conditions of the product HI stream (e.g. temperature, pressure, phase, concentrations, flow rate, etc.) including, but not limited to, compressors, valves, flash tanks, tanks, liquid-gas contact units, columns, pumps, heat exchangers, separation units, or any combination thereof.

While this invention has been described as relative to exemplary designs, the present invention may be further modified within the spirit and scope of this disclosure. Further, this application is intended to cover such departures from the present disclosure as come within known or customary practice in the art to which this invention pertains.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### EXAMPLES

### Example 1: Removal of I₂ from HI Using Silicalite

Hydrogen iodide (HI) was prepared on a bench scale according to the process described herein, and was circulated through a column containing silicalite. Specifically, about 3 kg of HI were circulated at room temperature through a column containing 150 g of silicalite. The dimensions of the column were 1-inch OD×20-inch L. The material was circulated using a Diaphragm pump. Table 1 shows the acid/base- and redox titrations of the starting sample and sample taken after 6 days. Results show a significant reduction in the concentration of elemental iodine and non-volatile residue. The concentration of elemental iodine was reduced by 88.5%, from 762 ppm to 87 ppm.

TABLE 1
Use of silicalite for removal of iodine from HI

| HI Sample | HI Assay, % | Free Iodine, ppm | NVR, ppm |
|---|---|---|---|
| Before circulation | >99 | <762 | <104 |
| After circulation, 2 days | >99 | <223 | <201 |
| After circulation, 6 days | >99 | <87 | <57 |

Adsorbent: Silicalite; Temperature: RT, Pressure: ~90-100 psig

It is demonstrated that using silicalite reduces the level of elemental iodine in HI. However, determination of the exact HI assay is difficult because attendant iodine reacts with caustic during the acid-base titration. Note that the free iodine concentration determined by redox titration is a combined number for both HI₃ and elemental iodine. More accurate determination of the HI assay can be attained by 1H NMR. To that effect, a sample of silicalite was exposed to crude HI and analyzed after a predetermined period by 1H NMR to determine concentration of HI, HI₃, and hydrogen gas. Specifically, the silicalite sample was dried at 130 deg C, and charged to 150 mL-sample cylinder. The sample cylinder was pressured checked at 250 psig, evacuated, and then charged with crude HI. In another sample cylinder, just the crude HI was charged without silicalite. After 10 days, HI samples from the cylinders were analyzed by ¹H NMR.

Based on the relative intensities of the signals related to HI and its decompositions products it is possible to determine the mol % of each species present in solution to obtain an estimate of the purity of the HI. Because HI and HI₃ are in equilibrium it is understood that it will shift based on several factors such as concentration and temperature. It is also understood that H₂ gas will partition between the liquid and gas phases based on its solubility under these conditions. Nevertheless, an estimate of the relative purity of HI samples was made based on the NMR data and is presented in Table 2. The results demonstrate that silicalite is highly effective in reducing HI₃ concentration in the HI sample. A corresponding decrease in free H₂ supports this finding.

TABLE 2
Summary HI Purity Determination for
HI Samples by 1H NMR Spectroscopy

| | | |
|---|---|---|
| HI | HI3 | H2 |

1HNMR (Starting Crude HI)

| | | | |
|---|---|---|---|
| 1H NMR | 33.99 | 0.48 | 1 |
| % Product | 97.2 | 1.4 | 1.4 |

1H NMR (HI After Contact with Silicalite)

| | | | |
|---|---|---|---|
| 1H NMR | 417.05 | 1.56 | 1.00 |
| % Product | 99.5 | 0.4 | 0.1 |

To estimate the iodine adsorption capacity for silicalite, at room temperature and atmospheric pressure, a column charged with silicalite was installed after the iodine collectors to remove entrained iodine in the effluent stream from the collectors before the HI is recovered in the product collection cylinder. About 150 g of silicalite were charged to the column. The dimensions of the column are 1 inch OD×20 inch L. As shown in Table 3, after 468 h the weight of the silicalite increased by 112.5 g from 150 g to 262.5 g, corresponding to about 75% capacity. The spent silicalite sample may be regenerated by purging with hot inert gas or washing with a suitable solvent that dissolves iodine species. Non-limiting examples of the solvent include ethanol, methylene chloride, chloroform, carbon tetrachloride and hexanes.

TABLE 3
Determination of equilibrium iodine
adsorption capacity of silicalite

| Time on stream, h | 0 | 144 | 468 |
|---|---|---|---|
| Weight of reactor + silicalite, g | 1233 | 1312.5 | 1345.5 |
| Weight of Silicalite, g | 150 | 229.5 | 262.5 |
| Change in Weight of Silicalite, g | N/A | 79.5 | 112.5 |
| Change in Weight of Silicalite, % | N/A | 53 | 75 |

Dimensions of column: 1 inch OD × 20 inch′ L; contains 150 g of silicalite

### Example 2 (Comparative): Removal of I₂ from HI Using Activated Carbon

Hydrogen iodide was prepared according to example 1 above and circulated through a column containing activated carbon (OLC12×30). Specifically, ˜469.6 g of HI were circulated at room temperature through a column containing 14.9 g of activated carbon. The material was circulated using a diaphragm pump, in a closed loop, for 24 h. As shown in Table 4 acid/base- and redox titrations of the starting sample and sample collected after circulation reveal significant increases in the concentration of elemental iodine. The concentration of elemental iodine increased by 546.5%, from 822 ppm to 5315 ppm. Additionally, the weight of the activated carbon increased by ˜119% (24 g). This indicates that activated carbon does not selectively remove iodine and HI₃ from HI. Rather it adsorbs both species leading to the significant weight increase. Therefore, activated carbon is not a suitable adsorbent to use for reduction of the concentration of elemental iodine in HI. Note that the redox titration value for free iodine reported is a combined value for attendant elemental iodine and HI₃.

TABLE 4
Use of activated carbon (OLC12x30)
for removal of iodine from HI

| HI Sample | HI Assay, % | Free Iodine, ppm |
|---|---|---|
| Before circulation | >98 | 822 |
| After circulation, 1 day | >98 | 5315 |

Adsorbent: Activated carbon (OLC12x30); Temperature: RT, Pressure: ~90-100 psig

### Example 3: Material Balances for Quenching Separation

In this example, an exemplary material balance (MB) was calculated for the four different quenching systems shown in FIGS. 3-6. The calculations were completed using ASPEN Plus simulation software. The simulation was run with iodine, hydrogen, HI, and trace amounts of water, and relied upon a basis of 1,000 lb/hr of flow from the reactor effluent stream. The results are summarized in tables 5-8 below, with the stream numbers corresponding to the same labels as shown in the figures.

TABLE 5a
Example MB for FIG. 3 ICS Removal System (1/2)

| | Units | S40 | S54 | S58 | S66 | S56 | S68 |
|---|---|---|---|---|---|---|---|
| Phase--> | | Vapor | Vapor | Vapor | Liquid | Liquid | Vapor |
| Temp. | F. | 600 | 30 | 24 | 11 | 35 | 11 |
| Pressure | psia | 60 | 60 | 58 | 58 | 58 | 58 |
| I₂ | lb/hr | 76.21 | 0.06 | 0.00 | 0.00 | 0.06 | 0.00 |
| H₂ | lb/hr | 14.32 | 14.32 | 14.32 | 0.00 | 0.00 | 14.32 |
| HI | lb/hr | 909.43 | 4,539.57 | 4,514.82 | 2,784.98 | 2,809.72 | 1,729.84 |
| Water | lb/hr | 0.04 | 0.00 | 0.00 | 0.00 | 0.00 | 0.00 |
| Total | lb/hr | 1,000.00 | 4,553.95 | 4,529.14 | 2,784.98 | 2,809.79 | 1,744.16 |
| Flows | | | | | | | |

TABLE 5b
Example MB for FIG. 3 ICS Removal System (2/2)

| | Units | S72 | S42 | S76 | S46 | S48 | S52 |
|---|---|---|---|---|---|---|---|
| Phase--> | | Vapor | Liquid | Liquid | Liquid | Vapor | Liquid |
| Temp. | F. | −45 | 65 | −45 | 30 | 180 | 240 |
| Pressure | psia | 205 | 150 | 205 | 60 | 70 | 70 |
| I₂ | lb/hr | — | — | — | 85.47 | 9.27 | 76.21 |
| H₂ | lb/hr | 14.32 | — | 0.00 | 0.00 | 0.00 | — |
| HI | lb/hr | 53.76 | 827.21 | 848.41 | 620.88 | 614.08 | 6.80 |
| Water | lb/hr | — | 0.01 | — | 0.09 | 0.04 | 0.05 |
| Total | lb/hr | 68.07 | 827.22 | 848.41 | 706.44 | 623.38 | 83.06 |
| Flows | | | | | | | |

TABLE 6a
Example MB for FIG. 4 ICS Removal System (1/2)

| | Units | S80 | S90 | S96 | S98 | S92 | S102 |
|---|---|---|---|---|---|---|---|
| Phase −> | | Vapor | Vapor | Vapor | Liquid | Liquid | Vapor |
| Temp. | F. | 600 | 30 | 24 | 11 | 24 | 11 |
| Pressure | psia | 60 | 60 | 58 | 58 | 58 | 58 |
| I₂ | lb/hr | 76.21 | 0.06 | 0.00 | 0.00 | 0.06 | 0.00 |
| H₂ | lb/hr | 14.32 | 14.32 | 14.32 | 0.00 | 0.00 | 14.32 |
| HI | lb/hr | 909.43 | 4,545.72 | 4,504.54 | 2,774.70 | 2,815.88 | 1,729.84 |
| Water | lb/hr | 0.04 | 0.00 | 0.00 | 0.00 | 0.00 | — |
| Total | lb/hr | 1,000.00 | 4,560.10 | 4,518.86 | 2,774.70 | 2,815.94 | 1,744.16 |
| Flows | | | | | | | |

TABLE 6b
Example MB for FIG. 4 ICS Removal System (2/2)

| | Units | S104 | S82 | S108 | S84 | S86 | S88 |
|---|---|---|---|---|---|---|---|
| Phase −> | | Vapor | Liquid | Liquid | Liquid | Vapor | Liquid |
| Temp. | F. | −45 | 65 | −45 | 30 | 240 | 240 |
| Pressure | psia | 205 | 150 | 205 | 60 | 70 | 70 |
| I₂ | lb/hr | 0.00 | — | 0.00 | 85.51 | 9.30 | 76.21 |
| H₂ | lb/hr | 14.32 | — | 0.00 | 0.00 | 0.00 | — |
| HI | lb/hr | 53.76 | 827.21 | 848.41 | 623.20 | 616.40 | 6.80 |
| Water | lb/hr | — | 0.01 | — | 0.09 | 0.04 | 0.05 |
| Total | lb/hr | 68.07 | 827.22 | 848.41 | 708.79 | 625.74 | 83.06 |
| Flows | | | | | | | |

TABLE 7a
Example MB for FIG. 5 ICS Removal System (1/2)

| | Units | S110 | S120 | S122 | S124 |
|---|---|---|---|---|---|
| Phase--> | | Vapor | Vapor | — | Vapor |
| Temp. | F. | 600 | 30 | — | 29 |
| Pressure | psia | 60 | 60 | — | 58 |
| I₂ | lb/hr | 76.21 | 0.06 | — | 0.06 |
| H₂ | lb/hr | 14.32 | 14.32 | — | 14.32 |
| HI | lb/hr | 909.43 | 4,504.82 | — | 4,504.82 |
| Water | lb/hr | 0.04 | 0.00 | — | 0.00 |
| Total | lb/hr | 1,000.00 | 4,519.20 | — | 4,519.20 |
| Flows | | | | | |

TABLE 7b
Example MB for FIG. 5 ICS Removal System (2/2)

| | Units | S126 | S112 | S130 | S114 | S116 | S118 |
|---|---|---|---|---|---|---|---|
| Phase--> | | Vapor | Liquid | Liquid | Liquid | Vapor | Liquid |
| Temp. | F. | −45 | 65 | −45 | 30 | 240 | 240 |
| Pressure | psia | 205 | 150 | 205 | 60 | 70 | 70 |
| I₂ | lb/hr | 0.00 | — | 0.00 | 85.31 | 9.17 | 76.15 |
| H₂ | lb/hr | 14.32 | — | 0.00 | 0.00 | 0.00 | — |
| HI | lb/hr | 53.76 | 3,602.59 | 846.20 | 616.53 | 609.33 | 7.20 |
| Water | lb/hr | 0.00 | 0.04 | 0.00 | 0.13 | 0.05 | 0.08 |
| Total | lb/hr | 68.07 | 3,602.62 | 846.20 | 701.97 | 618.55 | 83.42 |
| Flows | | | | | | | |

TABLE 8a
Example MB for FIG. 6 ICS Removal System (1/2)

| | Units | S140 | S146 | S148 | S150 |
|---|---|---|---|---|---|
| Phase | | Vapor | Vapor | — | Vapor |
| Temp. | F. | 600 | 20 | — | 20 |
| Pressure | psia | 60 | 60 | — | 58 |
| I₂ | lb/hr | 42.84 | 0.04 | — | 0.04 |
| H₂ | lb/hr | 27.62 | 27.62 | — | 27.62 |
| HI | 1b/hr | 929.41 | 4,193.94 | — | 4,193.94 |
| Water | lb/hr | 0.13 | 0.00 | — | 0.00 |
| Total | lb/hr | 1,000.00 | 4,221.59 | — | 4,221.59 |
| Flows | | | | | |

TABLE 8b
Example MB for FIG. 6 ICS Removal System (2/2)

| | Units | S158 | S142 | S162 | S154 | S144 | S152 | S156 |
|---|---|---|---|---|---|---|---|---|
| Phase | | Vapor | Liquid | Liquid | Liquid | Liquid | Vapor | Liquid |
| Temp. | F. | −45 | 65 | −45 | 125 | 20 | 302 | 302 |
| Pressure | psia | 205 | 150 | 205 | 205 | 60 | 205 | 205 |
| I₂ | lb/hr | 0.00 | — | 0.00 | 50.67 | 42.81 | 50.63 | 42.84 |
| H₂ | lb/hr | 27.62 | — | 0.00 | 0.00 | 0.00 | 0.00 | 0.00 |
| HI | lb/hr | 103.69 | 3,657.98 | 814.21 | 633.85 | 393.44 | 1,015.83 | 11.47 |
| Water | lb/hr | 0.00 | 0.04 | 0.00 | 1.36 | 0.16 | 1.36 | 0.16 |
| Total | lb/hr | 131.31 | 3,658.01 | 814.21 | 685.88 | 436.42 | 1,067.82 | 54.48 |
| Flows | | | | | | | | |

As shown in Tables 5-8, the quenching iodine removal system is configured to remove essentially all incoming iodine from the reactor effluent (see S9 contains negligible I₂). Furthermore, essentially all of the iodine is recycled back to the reactor, reducing the amount of wasted iodine and reducing potential feedstock costs.

### ASPECTS

Aspect 1 is a process for removing at least one iodine-containing species from a mixture comprising the at least one iodine-containing species and hydrogen iodide. The process includes providing a feedstock comprising the mixture, passing the feedstock through at least one gas-liquid contact unit, wherein the feedstock is contacted with a liquid comprising hydrogen iodide.

Aspect 2 is the process of Aspect 1, wherein the feedstock comprises at least one of a vapor, a partial vapor, and a partial de-sublimated compound.

Aspect 3 is the process of Aspect 1 or Aspect 2, wherein the feedstock comprises iodine in an amount less than 30 wt. % based on the total weight of the feedstock.

Aspect 4 is the process of any of Aspects 1-3, wherein the gas-liquid contact unit generates a bottom liquid stream with a greater concentration of iodine-containing species than the feedstock after the feedstock has passed through the gas-liquid contact unit.

Aspect 5 is the process of Aspect 4, further comprising evaporating a portion of the bottom liquid stream to generate a vaporized recycle stream and a liquid recycle stream.

Aspect 6 is the process of Aspect 4 or Aspect 5, further comprising combining the liquid recycle stream and the feedstock, and passing the vaporized recycle stream to the gas-liquid contact unit.

Aspect 7 is the process of any of Aspects 4-6, wherein the further unit is a distillation column and the vaporized recycle stream is passed to the distillation column.

Aspect 8 is the process of any of Aspects 1-7, wherein the at least one gas-liquid contact unit comprises at least one of submerged spargers, distillation trays, shower curtain trays, slant trays, shed trays, random packing, structured packing, and liquid spraying devices or nozzles.

Aspect 9 is the process of any of Aspects 1-8, wherein the further unit is a distillation column, and the process further comprises the step of separating the feedstock in the distillation column into a recycle hydrogen stream, a liquid hydrogen iodide product stream, and a recycle liquid hydrogen iodide stream.

Aspect 10 is the process of any of Aspects 1-9, wherein the at least one iodine-containing species comprises at least one of elemental iodine, iodohydrocarbons, iodoketones, iodoaldehydes, and HI₃.

Aspect 11 is the process of any of Aspects 1-10, wherein the further unit is a first distillation column, and the process further comprises the step of passing the feedstock to a second distillation column, wherein the bottoms stream from the first distillation column is passed back through the liquid-gas contact unit.

Aspect 12 is a process for removing at least one iodine-containing species from a mixture comprised of at least one iodine-containing species and hydrogen iodide. The process includes providing a feedstock comprising the mixture; and passing the feedstock through at least one column charged with an adsorbent material to obtain a stream with a lesser concentration of the at least one iodine-containing species than in the feedstock.

Aspect 13 is the process of Aspect 12, wherein passing the feedstock through at least one column charged with adsorbent material comprises recirculating the feedstock through the at least one column.

Aspect 14 is the process of Aspect 12 or Aspect 13, wherein the at least one column is operated at a temperature of about −50° C. to about 120° C. and at a pressure of about −10 psig to about 600 psig.

Aspect 15 is the process of any of Aspects 12-14, wherein the at least one iodine-containing species comprises at least one of elemental iodine, iodohydrocarbons, iodoketones, iodoaldehydes, and HI₃.

Aspect 16 is the process of any of Aspects 12-15, wherein the adsorbent material comprises silicalite.

Aspect 17 is the process of Aspect 16, wherein the silicalite has a pore size of at least 2 Å, and wherein surface area of the silicalite ranges from about 50 m²/g to about 3000 m²/g.

Aspect 18 is a process for removing at least one iodine-containing species from a mixture comprising the at least one iodine-containing species and hydrogen iodide. The process includes passing the feedstock through at least one iodine-containing species removal unit configured to reduce the concentration of the at least one iodine-containing species; and passing the feedstock to a further unit selected from the group consisting of a reactor, a distillation column, a heat exchanger, a compressor, a de-sublimator, and a condenser.

Aspect 19 is the process of Aspect 18, wherein passing the feedstock comprises recycling at least a portion of the feedstock through the at least one iodine-containing species removal unit before passing the feedstock to the further unit.

Aspect 20 is the process of Aspect 18 or Aspect 19, wherein the at least one iodine-containing species removal unit comprises an adsorption column.

Aspect 21 is the process of Aspect 20, wherein the adsorption column is charged with an adsorbent material.

Aspect 22 is the process of Aspect 21, wherein the adsorbent material comprises silicalite.

Aspect 23 is the process of any of Aspect 18 or Aspect 19, wherein the at least one iodine-containing species removal unit comprises a gas-liquid contact unit.

Aspect 24 is the process of Aspect 23, wherein the gas-liquid contact unit generates a bottom liquid stream with a greater concentration of iodine-containing species than the feedstock after the feedstock has passed through the gas-liquid contact unit.

Aspect 25 is the process of Aspect 24, further comprising evaporating a portion of the bottom liquid stream in an evaporator to generate a vaporized recycle stream and a liquid recycle stream.

Aspect 26 is the process of Aspect 24 or Aspect 25, further comprising combining the liquid recycle stream and the feedstock, and passing the vaporized recycle stream to the gas-liquid contact unit.

Aspect 27 is the process of any of Aspects 24-26, wherein the further unit is a distillation column and the vaporized recycle stream is passed to the distillation column.

Aspect 28 is the process of any of Aspects 23-26, wherein the at least one gas-liquid contact unit comprises at least one of submerged spargers, distillation trays, shower curtain trays, slant trays, shed trays, random packing, structured packing, and liquid spraying devices or nozzles.

Aspect 29 is the process of any of Aspects 18-28, wherein the further unit is a distillation column, and the process further comprises the step of separating the feedstock in the distillation column into a recycle hydrogen stream, a liquid hydrogen iodide product stream, and a recycle liquid hydrogen iodide stream.

Aspect 30 is the process of any of Aspects 18-29, wherein the at least one iodine-containing species comprises at least one of elemental iodine, iodohydrocarbons, iodoketones, iodoaldehydes, and HI₃.

Aspect 31 is the process of any of Aspects 1-11, or Aspects 18-29, wherein the further unit is a reactor or reactors configured to produce trifluoroiodomethane.

Aspect 32 is the process of Aspect 1, further comprising passing the feedstock to a further unit selected from the group consisting of a column, a reactor, a compressor, a de-sublimator, and a condenser.

Aspect 33 is the process of Aspect 1, wherein the further unit is a distillation column, and the process further comprises the step of separating the feedstock in the distillation column into a recycle stream comprising hydrogen, a liquid hydrogen iodide product stream, a recycle liquid hydrogen iodide stream, and a bottom liquid stream with a greater concentration of iodine-containing species than the distillation column feeds.

What is claimed is:

1. A process for removing at least one iodine-containing species from a mixture comprised of the at least one iodine-containing species and hydrogen iodide, the process comprising:
providing a feedstock comprising the mixture,
passing the feedstock through at least one gas-liquid contact unit, wherein the feedstock is contacted with a liquid comprising hydrogen iodide.

2. The process of claim 1, further comprising passing the feedstock to a further unit selected from the group comprising of a column, a reactor, a compressor, a de-sublimator, and a condenser.

3. The process of claim 1, wherein the gas-liquid contact unit generates a bottom liquid stream with a greater concentration of iodine-containing species than the feedstock after the feedstock has passed through the gas-liquid contact unit.

4. The process of claim 3, further comprising evaporating a portion of the bottom liquid stream to generate a vaporized recycle stream and a liquid recycle stream.

5. The process of claim 3, further comprising combining the liquid recycle stream and the feedstock, and passing the vaporized recycle stream to the gas-liquid contact unit.

6. The process of claim 3, wherein the further unit is a distillation column and the vaporized recycle stream is passed to the distillation column.

7. The process of claim 1, wherein the at least one gas-liquid contact unit comprises at least one of submerged spargers, distillation trays, shower curtain trays, slant trays, shed trays, random packing, structured packing, and liquid spraying devices or nozzles.

8. The process of claim 1, wherein the further unit is a distillation column, and the process further comprises the step of separating the feedstock in the distillation column into a recycle stream comprises hydrogen, a liquid hydrogen iodide product stream, and a recycle liquid hydrogen iodide stream.

9. The process of claim 1, wherein the at least one iodine-containing species comprises at least one of elemental iodine, iodohydrocarbons, iodoketones, iodoaldehydes, and HI₃.

10. The process of claim 1, wherein the further unit is a first distillation column, and the process further comprises the step of passing the feedstock to a second distillation column, wherein the bottoms stream from the first distillation column is passed back through the liquid-gas contact unit.

11. The process of claim 1, wherein the further unit is a distillation column, and the process further comprises the step of separating the feedstock in the distillation column into a recycle stream comprising hydrogen, a liquid hydrogen iodide product stream, a recycle liquid hydrogen iodide stream, and a bottom liquid stream with a greater concentration of iodine-containing species than the distillation column feeds.

12. A process for removing at least one iodine-containing species from a mixture comprised of at least one iodine-containing species and hydrogen iodide, the process comprising:
providing a feedstock comprising the mixture; and
passing the feedstock through at least one column charged with an adsorbent material to obtain a stream with a lesser concentration of the at least one iodine-containing species than in the feedstock.

13. The process of claim 12, wherein passing the feedstock through at least one column charged with adsorbent material comprises recirculating the feedstock through the at least one column.

14. The process of claim 12, wherein the at least one column is operated at a temperature of about −50° C. to about 120° C. and at a pressure of about −10 psig to about 600 psig.

15. A process for removing at least one iodine-containing species from a mixture comprising the at least one iodine-containing species and hydrogen iodide, the process comprising:
passing the feedstock through at least one iodine-containing species removal unit comprising an adsorption column and a gas-liquid contactor.
